(19) United States
(12) Patent Application Publication
(10) Pub. No.: US 2009/0170462 A1
(43) Pub. Date: Jul. 2, 2009

(54) Method for Attenuating a High Frequency Emission From a Clocked System

(76) Inventor: Rainer Gschwind-Schilling, Weissach-Flacht (DE)

Correspondence Address: KENYON & KENYON LLP, ONE BROADWAY, NEW YORK, NY, 10004, US

(21) Appl. No.: 11/886,699

(22) PCT Filed: Jan. 31, 2006
(86) PCT No.: PCT/EP2006/050541

§ 371 Date: Dec. 17, 2008

(30) Foreign Application Priority Data
Mar. 24, 2005 (DE) 10 2005 013 593.5

(51) Int. Cl. H04B 1/10

(52) U.S. Cl. 455/296

(57) ABSTRACT

The method provides the following steps: determining a temporally averaged maximum value, which the power of the high frequency emission of the clocked system must not exceed in a predefined frequency band; modulating an oscillating frequency provided by the oscillator as the excitation source with a frequency deviation so that the average power is below the maximum value in the predefined frequency band; determining a bandwidth of a wireless receiver; and modulating the oscillation frequency with a modulation frequency that is greater than the bandwidth of the wireless receiver.

### BACKGROUND INFORMATION

A clocked system includes an oscillation device that synchronizes a primary clock pulse for the switching operations in the clocked system by transmitting a clock signal. The switching operations within the clocked system cause interference signals or high frequency emissions in the frequency range of the primary clock pulse and clock pulses that are derived from the primary clock pulse, for example by internal multipliers of the system. The primary clock pulses and derived clock pulses typically used today operate in a frequency range from 10 MHz to over 1 GHz. Despite filtering devices, some of which are quite sophisticated, it is not possible to completely suppress the interference signals or high frequency emissions present in signal circuits, power supply circuits, or that are radiated through the air. For the sake of simplicity, the term high frequency emission will hereinafter also refer to the interference signals occurring in the wiring.

High frequency emission may give rise to interferences in related circuits and impair the functioning of those circuits. The consequences of this are particularly damaging if the power of the high frequency emission is high in a frequency range that is used by the related circuits. This may result in undesirable interference effects. Therefore, maximum limits must be placed on the power of the emission which must not exceed an interference emission.

The frequencies that are used for wireless transmission, and in particular radio reception, are especially sensitive to such interference. The interference signals may cause undesirable whistles during radio reception.

### SUMMARY OF THE INVENTION

The present invention provides a method that reduces the power of a high frequency emission of a clocked system in a frequency range, and a device.

The method according to the present invention provides the following steps: determining a temporally averaged maximum value, which the power of the high frequency emission of the clocked device must not exceed in a predefined frequency band; using a frequency deviation to modulate an oscillating frequency of the oscillator as the excitation source in such a way that the average power is below the maximum value in the predefined frequency band; determining a bandwidth of a wireless receiver; using a frequency deviation (modulation frequency/modulation deviation) that is greater than the bandwidth of the wireless receiver of the predefined frequency band to modulate the oscillating frequency. The bandwidth may be stored in a memory device, or it may be supplied via individual circuits and components.

The underlying idea is to distribute the power of the high frequency emission in the predefined interfered with frequency ranges over a larger frequency range. This reduces the effective, temporally averaged power in sensitive frequency ranges. The term attenuation is to be understood in this sense, as described previously. This is particularly advantageous if the other circuits are only interfered with in a given frequency range and interference only occurs when the interference signal is applied at a constant minimum power for longer than a critical period. Since filter and buffer devices are effectively able to block transient interferences, the method of the present invention effectively suppresses the interference of related circuits by the clocked system. A listener is not aware of brief interferences in radio reception.

The device of the present invention for a clocked system with an oscillator as the excitation source, in which the oscillator is configured in such a way that its oscillating frequency is adjustable via a control signal, has a modulation oscillator that is connected to an oscillator as the excitation source and is configured to transmit a periodic control signal to modulate an oscillating frequency of the oscillator as the excitation source in such a way that the average power of a high frequency emission is below a maximum value in a predefined frequency band.

One refinement of the present invention provides for the modulation frequency to be set to more than 400 kHz. This frequency is sufficiently high to prevent interference from affecting most VHF receivers.

Another refinement of the present invention provides for the following steps: collecting a signal corresponding to the power of the high frequency emission; controlling the frequency deviation in response to the signal in such a way that the signal remains below a signal value corresponding to the maximum signal.

A further refinement of the present invention provides for the following steps: recording a signal corresponding to the power of the high frequency emission; determining the frequency deviation based on a ratio of the maximum value to the signal.

Yet another refinement of the present invention provides for an amplifying device to be disposed between the oscillator as the excitation source and the modulation oscillator to amplify the control signal, this amplifying device having an adjustable amplifier for adjusting the frequency deviation, which is proportional to the control signal.

### BRIEF DESCRIPTION OF THE DRAWINGS

FIG. 1 shows a block diagram of a specific embodiment of the present invention.

FIG. 2 shows a schematic representation of a frequency range used for a stereo receiver.

FIG. 3 shows a schematic representation of a frequency range used by a broadcast radio receiver.

FIG. 4 shows a block diagram of a broadcast radio receiver.

FIG. 5 shows a schematic representation to explain a difficulty of the present invention.

FIG. 6 shows a schematic representation of a frequency range to explain a specific embodiment of the present invention.

### DETAILED DESCRIPTION

Identical reference numerals in the figures refer to identical or functionally equivalent components unless otherwise indicated.

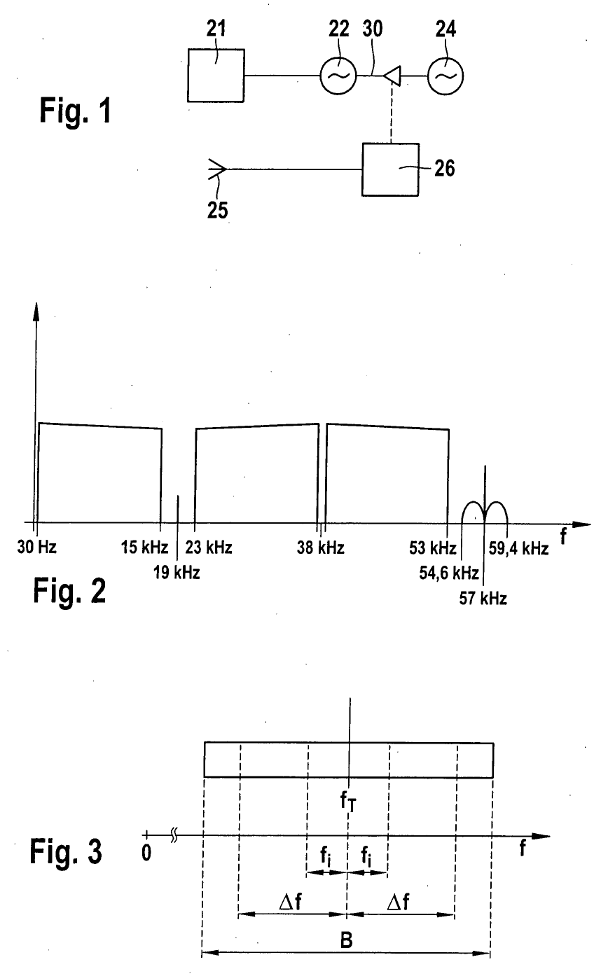

FIG. 1 shows a specific embodiment of the present invention. A clocked system 21, for example a microprocessor or a clocked voltage converter, is connected to an oscillator 22 as the excitation source that predefines a primary clock pulse with an oscillating frequency f_{T}. Oscillator 22 is configured in such a way that oscillating frequency f_{T} is able to be changed via a control signal 30. This control signal 30 is supplied by a modulation oscillator 24. Control signal 30 is a periodic signal; it may be sinusoidal, triangular, or it may have another shape. When periodic control signal 30 is applied, oscillating frequency f_{T} is periodically modulated between a lower and an upper limit frequency by a predefined frequency deviation. Consequently, the high frequency emission is also modulated, so that its power is distributed over a frequency range corresponding to the frequency deviation. A maximum permissible high frequency emission may be determined in individual affected frequency ranges according to the known specifications of other circuits and legal stipulations. The frequency deviation is then adjusted so that the temporally averaged power of the high frequency emission is below the maximum permissible value in each relevant frequency range. The frequency deviation may be adjusted via a controllable amplifying device 23 that is situated between oscillator 22 and modulation oscillator 24 to amplify or attenuate control signal 30.

It is also possible to provide an antenna device 25 that records the high frequency emission of clocked system 21. The recorded high frequency emission is forwarded to a controller 26, which controls amplifying device 23 to increase the frequency deviation on the basis of the recorded high frequency emission. This may be effected for example using negative feedback, in which case controller 26 is equipped with corresponding internal signal amplifiers and outputs the amplified signals to amplifying device 23. Since the oscillation frequency changes often in this case, it may cause interference in the switching behavior of clocked system 21. Accordingly, another embodiment provides for the use of a controller 26 having suitable hysteresis or memory of some other type. A further embodiment determines the frequency deviation based on the product of the relevant frequency range multiplied by the ratio of the recorded high frequency emission to the maximum permissible high frequency emission. Controller 26 is equipped with a corresponding data processing device for this purpose.

The specific embodiments described in the preceding are suitable for preventing interferences in other circuits, such as are used for example in a motor vehicle. However, if the intention is to suppress interferences caused by high frequency emissions in broadcast radio reception, in particular in VHF reception of frequency-modulated carrier signals (FM receivers), other aspects must also be considered, as described in the following.

An FM receiver collects the modulation of oscillating frequency f_{T} (referred to in broadcast radio technology as the carrier frequency) as an information signal with a frequency corresponding to modulation frequency f_{M} and an amplitude corresponding to the frequency deviation. Accordingly, with a sinusoidal control signal 30 having modulation frequency f_{M} (corresponding to the information frequency in broadcast radio technology), a radio listener hears whistling at a pitch corresponding to modulation frequency f_{M}. Modulation frequency f_{M} must therefore be chosen from outside the ranges that are demodulated by an FM receiver. For this purpose, the frequency range used to transmit a carrier frequency f_{T} for a typical stereo signal of a VHF broadcast transmitter is shown in FIG. 2. One mono signal and two stereo signals are transmitted in three bands, and data signals are also broadcast in a band between 54.6 kHz and 59.6 kHz to identify the radio station and/or the music title. Therefore, modulation frequency f_{M} must be at least 59.4 kHz, otherwise it will be converted into an audible radio signal by an FM receiver.

FIG. 3 shows a schematic representation of the frequency range used by a single transmitter and/or receiver in a VHF system. Bandwidth B is disposed symmetrically about a carrier frequency f_{T}, fᵢ designating the information frequency and Δf the frequency deviation. Both information frequency fᵢ and frequency deviation Δf are within the bandwidth.

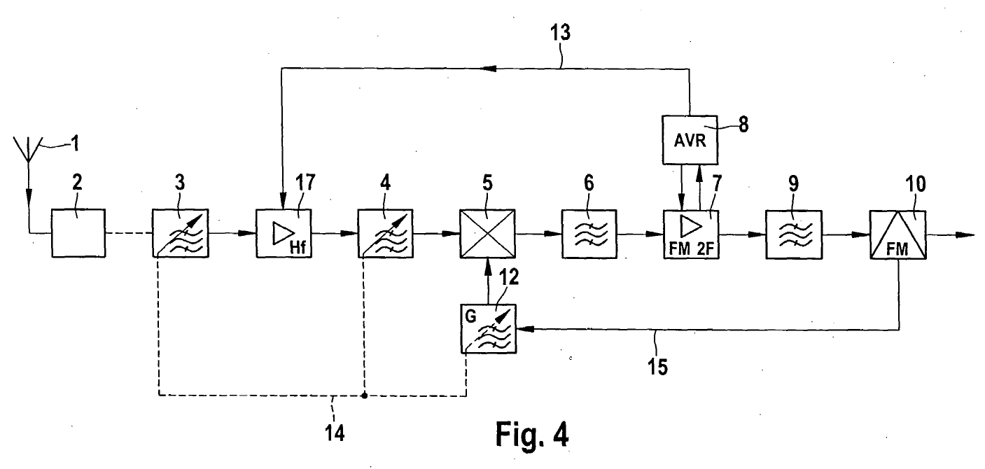

Surprisingly, however, interference signals are evident in the reception of VHF signals even for modulation frequencies f_{M}>60 kHz. One reason for this is the configuration of conventional FM receivers, the first reception levels of which are schematically shown in FIG. 4. A signal is received by antenna 1 and passed in the following sequence through an amplifier 2 to a controllable bandpass filter 3, an adjustable high frequency amplifier 17, a second adjustable bandpass filter 4, and a mixer 5. Mixer 5 also receives the carrier frequency, which is generated by a high frequency generator 12. High frequency generator 12 is typically equipped with adjustable frequency elements, such as capacitance diodes, which are adjustable via control signal 15. The signal that is mixed in mixer 5 is forwarded to an intermediate loop filter 6, which blocks all signals except those that match the bandwidth of the radio receiver. The filtered signal is passed to another amplifier 7, which communicates with a controller 8 and adapts the modulation amplitude of high frequency amplifier 17 via a control signal. The intermediate frequency signal is forwarded to a second intermediate loop filter 9. Based on the demodulated signal, a control device/demodulator 10 uses a control signal 15 to fine tune the frequency of high frequency oscillator 12 if the demodulated carrier signal is not 0 Hz; in other words, the carrier signal, modulated with the frequency from the high frequency oscillator, provides the intermediate frequency.

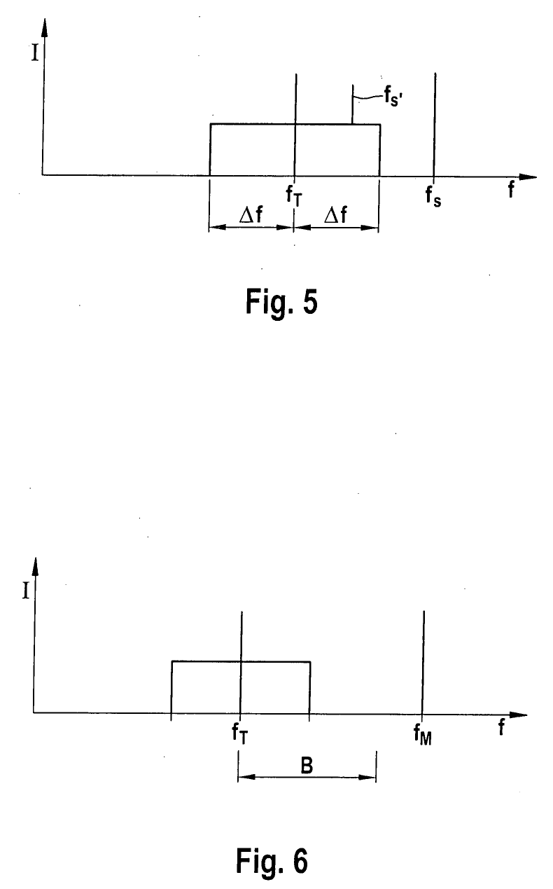

If the frequency-modulated signal is received with a large frequency deviation, controllable bandpass filters 3, 4 convert the frequency modulation to an amplitude modulation. The reason for this is that some frequencies within the frequency deviation are attenuated more effectively than others by filters 3, 4. Since information signals in FM reception only include a small frequency deviation, resulting in negligible conversion to amplitude modulation, no measures have been adopted in conventional FM receivers to prevent the non-linear effects of such amplitude modulation in mixer 5. The causes of these non-linear effects include parasitic frequency modulation of the mixed carrier signal after mixer 5, because the amplitude-modulated interference signal impinges on the mixer via path 4. The interference signal may be present on path 4 in amplitude-modulated or demodulated form, depending on the design of the receiver. This causes interference in reception, which may manifest itself as irritating whistling noises. FIG. 5 shows that, by virtue of non-linear effects, a high frequency emission having a frequency of fₛ may result in an interference at a lower frequency f_{s′}, below 60 kHz.

The amplitude-modulated interference in the filter is also able to be mixed with the frequency-modulated signal by capacitance diodes. This new, frequency-modulated signal then causes whistling on the radio.

A specific embodiment of the present invention exploits the fact that intermediate loop filters 6, 9 filter out signals that are outside the bandwidth of the intermediate frequency filter. Signals that have a greater modulation frequency f_{M} are treated as signals from a transmitter with an adjacent transmission frequency, and are accordingly suppressed by intermediate loop filters 6, 9. This is why an oscillation signal is modulated with a modulation frequency f_{M} that is greater than bandwidth B of the broadcast radio receiver. Then the parasitic frequency modulations do not pass through intermediate loop filters 6, 7, and are unable to affect controller 10 and high frequency generator 12. Interference suppression frequencies are typically higher than 400 kHz. FIG. 6 indicates schematically that a modulation frequency f_{M} must be greater than the bandwidth.

1-6. (canceled)

7. A method for attenuating a high frequency emission of a clocked system using an oscillator serving as an excitation source, the method comprising:
determining a temporally averaged maximum value, which a power of the high frequency emission must not exceed in a predefined frequency band;
modulating an oscillating frequency of the oscillator serving as the excitation source with a frequency deviation in such a way that an average power in the predefined frequency band is below the maximum value;
determining a bandwidth of a wireless receiver of the predefined frequency band; and
modulating the oscillating frequency with a modulation frequency that is greater than the bandwidth of the receiver.

8. The method according to claim 7, wherein the modulation frequency is set to more than 400 kHz so as not to interfere with VHF reception.

9. The method according to claim 7, further comprising:
recording a signal corresponding to the power of the high frequency emission; and
controlling the frequency deviation that is applied in response to the signal in such a way that the signal remains below a signal value corresponding to a maximum signal.

10. The method according to claim 7, further comprising:
recording a signal corresponding to the power of the high frequency emission; and
determining the frequency deviation based on a ratio of the maximum value to the signal.

11. A device for attenuating a high frequency emission of a clocked system, comprising:
an oscillator serving as an excitation source, the oscillator being configured in such a way that an oscillation frequency thereof is adjustable via a control signal; and
a modulation oscillator connected to the oscillator serving as the excitation source and configured to transmit a periodic control signal to modulate the oscillation frequency of the oscillator serving as the excitation source in such a way that an average power of the high frequency emission is below a maximum value in a predefined frequency band.

12. The device according to claim 11, further comprising an amplifying device situated between the oscillator serving as the excitation source and the modulation oscillator to amplify the control signal, the amplifying device having an adjustable amplification for adjusting a frequency deviation.
